(19) United States
(12) Patent Application Publication
(10) Pub. No.: US 2007/0176093 A1
(43) Pub. Date: Aug. 2, 2007

(54) MASS SPECTROMETRY TARGET ASSEMBLY

(75) Inventors: Jaroslav Kukla, Salzburg (AT); Johannes Goller, Groedig (AT)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY DADC AUSTRIA AG, Anif (AT)

(21) Appl. No.: 11/617,879

(22) Filed: Dec. 29, 2006

(30) Foreign Application Priority Data
Jan. 27, 2006 (EP) 06001727.4

(51) Int. Cl. H01J 49/00

(52) U.S. Cl. 250/288

(57) ABSTRACT

A mass spectrometry target assembly for accommodating at least one analyte (1) for mass spectrometry is provided, said assembly comprising: a target substrate (10) having a substrate surface (11), at least one measuring element (2), wherein said target substrate (10) and said measuring element (2) are different components, said measuring element (2) is fixed to said substrate surface (11), and wherein an electrical contact (12,16) is provided between said measuring element (2) and said target substrate (10) and/or said substrate surface (11). Because said target substrate (10) and said measuring element (2) are different components, said measuring elements (2) can be fabricated separately from said target substrate (10) and a material for said target substrate (10) can be chosen independent from the material used for said measuring element (2).

The invention relates to a mass spectrometry target assembly, to an array of measuring elements, to a sample holder, to a method of manufacturing a mass spectrometry target assembly, to a method of manufacturing an array of measuring elements and to a method of manufacturing a sample holder.

In order to perform mass spectrometry analytes or samples need to be held on a target substrate.

Therefore, in prior art, a target substrate is processed entirely to form analyte presenting areas for holding said analytes, e.g. fluid samples. These analyte presenting areas are usually formed by outer hydrophobic areas and hydrophylic centers. This configuration causes a pre-concentration effect when a drop of sample solution is placed on sample presenting areas. Solvent evaporates and crystals of energy absorbing matrix combined with sample solids concentrate in center of sample presenting area.

In prior art, the processing of said target substrate is performed as a single piece, e.g. by using chemical vapour deposition (CVD), lithography, screen printing or the like for forming said analyte presenting areas.

However, processing of the whole target substrate, i.e. processing the target substrate entirely as one piece, can be expensive, e.g. when a diamond coating is used for forming said hydrophilic areas.

In some special cases, e.g. when a diamond coating is used for forming said sample presentation surface, processing of the whole target substrate, i.e. processing the target substrate entirely as one piece, can be expansive. Furthermore, it can be impossible to manufacture said target substrate comprising said analyte presenting areas, because the substrate material from which said target substrate is made may not be suited for producing a desired layer or coating. For example, when a diamond coating shall be formed on said target substrate, the target substrate needs to have a high temperature resistance, because during the coating process temperatures can reach between 700 to 800° C. Therefore, there is only a narrow selection of suitable materials available to be used as target substrate. For example, conductive polymer-based disposable substrates cannot be used for diamond coating due to low thermal resistance.

It is an object of the invention to provide a mass spectrometry target assembly and an array of measuring elements that can be fabricated without any constraints regarding material selection for said target substrate. Further, it is an object of the invention to provide a method of manufacturing a mass spectrometry target assembly and a method of manufacturing an array of measuring elements, which methods enable manufacturing without any constraints regarding material selection for said target substrate.

It is a further object of the invention to provide a sample holder and a method of manufacturing thereof, wherein said sample holder provides a memory for measuring results.

To achieve these objects, the invention provides a mass spectrometry target assembly for receiving or accommodating at least one analyte for analysis by mass spectrometry comprising: a target substrate having a substrate surface, at least one measuring element, wherein said target substrate and said measuring element are distinct, i.e. different components. That means, the target substrate can be seen as one working piece, whereas said measuring element is a different working piece. Said target substrate and said measuring element are therefore separate or separable components that can be processed separately from each other. Said measuring element is secured or fixed to said substrate surface, wherein an electrical contact is provided between said measuring element and said target substrate and/or said substrate surface, i.e. said measuring element and said target substrate and/or said substrate surface are electrically connected. The securing of said measuring element can be permanent or temporarily.

One aspect of the invention is therefore to provide said target substrate and said measuring element as different components that can be processed completely separate from each other, and then fixing said measuring element on said substrate surface. On said measuring element, a sample presentation area and/or a hydrophilic area is formed using e.g. nano-crystalline diamond coating requiring that said measuring element is essentially made of a material having a high thermal resistance. The target substrate may then be made of a different material that can be selected freely and independently from the material from which said measuring element is made. Thus, the invention provides a mass spectrometry target assembly free from any constraints regarding material selection for said target substrate, enabling a cheap and effective manufacturing of said mass spectrometry target.

It is noted that the term “mass spectrometry” is used throughout the application. However, the invention is likewise applicable in mass spectroscopy and this term could be used without any limitations synonymously. Further, the term “measuring element” always refers to seperate/distinct component or part, that can be fabricated independently from any other components or parts. However, the term “measuring spot” or the term “measuring zone” can also mean that such a spot/zone is formed integrally within other components, in particular within a target substrate.

In some embodiments, said measuring element includes or comprises a measuring element surface, and said measuring element surface includes or comprises a measuring coating or layer adapted to a specific type of analyte. In this invention, said layer is comprising but not restricted to diamond or Diamond-Like Carbon or DLC. Said coating or layer may be provided using any known technique, such as e.g. chemical vapour deposition (CVD), sputtering, spraying, screen or tampon printing, dipping, or the like.

In a further embodiment, said target substrate comprises or is essentially made of or at least in part made from a substrate material, for example a conductive polymer based substrate material. The substrate material can thereby be chosen independently from said measuring coating. Said measuring element can be plate-like and comprises or is essentially made of or at least in part made from a measuring element material, and said substrate surface is planar and has a substrate coating. Said target substrate can, but does not necessarily have to have a substrate coating, e.g. if substrate material is hydrophobic itself there is no need to coat it with an additional hydrophobic layer/coating. As mentioned, said substrate material and said measuring element material may be different, whereas each material may be selected freely and in correspondence with the needs of the type of coating for a certain type of analyte. It is also possible that said substrate coating and said measuring coating is different. For example, it is possible that said substrate coating is a hydrophobic coating, whereas said measuring coating is a hydrophilic coating, such that said analytes are held to or attracted from said measuring element.

When said measuring element comprises or is at least in part made of a conductive measuring element material, and said target substrate comprises or is essentially made of a conductive substrate material, said electrical contact can be provided between these two materials.

Said substrate surface can further comprise a conductive substrate coating or layer, wherein said electrical contact is then provided between said measuring element and said substrate coating and/or said measuring element material.

In some embodiments, said measuring coating is at least partly a hydrophilic coating, i.e. said measuring coating extends over at least part of the measuring element surface and is a hydrophilic coating. As mentioned, this enables, that analytes are held to said measuring elements.

In a further embodiment, said measuring coating comprises, but is not restricted to, a nano-crystalline diamond coating, and/or said measuring element material is selected from the group of materials consisting of titanium and nickel for nanocrystalline diamond layer or any other compatible material for other layers. This means, that only said measuring element surface may need to be coated with said nano-crystalline diamond coating or another suitable layer, which surface represents only a small area. Typically, a measuring element has a diameter of 3 mm, such that only small areas need to be coated with said nano-crystalline diamond coating enabling economical production of said mass spectrometry target assembly. The same applies for said measuring element material, because only relatively little amounts of said measuring element material, e.g. titanium or nickel, are needed for manufacturing said mass spectrometry target assembly enabling a cheap and economic manufacturing thereof.

Besides nanocrystalline diamond, any other coating which is compatible with chemicals used in mass spectrometry sample preparation can be used. For the body of said measuring element and/or for the target substrate, any mechanically stable and electrically conductive material can be used. Chemical compatibility with in mass spectrometry sample preparation used chemicals is convenient but necessary as used chemicals should not come into contact with the substrate material but measuring element.

In some embodiments, said measuring element comprises a measuring element body, said measuring coating comprises a hydrophilic layer located on said measuring body, and said measuring coating further comprises a hydrophobic layer located on said hydrophilic layer. Thereby, said hydrophobic layer covers said hydrophilic layer only partly, such that the non-covered area of said hydrophilic layer forms a hydrophilic area on said measuring element surface. E.g. the surface of said measuring element body is completely coated or covered by said hydrophilic layer, however, said hydrophilic layer is only covered partly by said hydrophobic layer, such that said hydrophilic layer lays open at least partly towards the surface of said measuring element. Said hydrophilic layer and said hydrophobic layer may be fabricated using e.g. chemical vapour deposition (CVD)-techniques, sputtering, spraying, screen or tampon printing, dipping, or the like or any other known techniques for manufacturing respective layers. Self assembled monolyaers can also be used.

In some embodiments, said hydrophilic layer is a nano-crystalline diamond layer and/or said hydrophobic layer is a hydrophobic organic or inorganic layer.

Since sample is in general an aqueous solution, any hydrophobic coating is suitable. Energy absorbing matrix is usually dissolved in a mixture of water and organic solvent, thus hydrophobic coating must be compatible with used solvents as well. It is possible to coat the measuring element with hydrogen terminated nanocrystalline diamond which is by nature hydrophobic and changing the termination in the center to oxygen terminated surface which is by nature hydrophilic. This can be done e.g. by heating the central area by laser to temperature above 150° C. in oxygen atmosphere. Organic films preferably comprise a polymer chosen from a group of perfluorinated hydrocarbons, alifatic hydrocarbons, polysilanes, organosilanes, halogenated hydrocarbons, aromatic hydrocarbons and combinations thereof. The main factor for selection of a particular material is the compatibility with chemicals used in the sample preparation.

Said measuring element may be fixed to said substrate surface using any known fixing technique, for example using an adhesive. For providing said electrical contact, it is possible to use a conductive adhesive.

It is also possible, in a different embodiment, that said measuring element is mechanically fixed to said substrate surface.

In this case, said measuring element may have a measuring element shape, said target substrate has at least one recess formed within said substrate surface, wherein said recess has a recess shape corresponding to said measuring element shape, and said measuring element is at least partly inserted into said recess. Said measuring element can be completely inserted into said recess, such that said measuring element surface is on the same level with said substrate surface, such that said measuring element may not project from said substrate surface.

In this embodiment, said measuring element may be fixed in said recess by an interference fit, i.e. mechanically.

In a further embodiment, said mass spectrometry target assembly comprises at least two different measuring elements, each having a different measuring coating, each adapted to a different type of analyte or sample. It is, thus, possible to combine various different measuring elements, i.e. measuring spots on one target substrate even when the manufacturing or surface preparation of the measuring element is not compatible with each other. By this combination it is possible to manufacture multi-analytical targets, i.e. target substrates. When mass spectrometry or mass spectroscopy is used for diagnosing diseases, said mass spectrometry target assembly allows manufacturing of multi-diagnosis card targets.

In a further embodiment, said target substrate can be a mass storage media, e.g. a standard mass storage media or any optical storage media, like a writable or rewritable compact disc (CD-R/RW), a writable or rewritable digital versatile disc (DVD-R/RW), a Blu-Ray Disc or the like, wherein said substrate surface is the surface of said mass storage media.

In this embodiment, said mass spectrometry target assembly may comprise a conductive layer located on said mass storage media, wherein the surface of said conductive layer is said substrate surface.

Further, said mass storage media can be a standard DVD comprising a lower half disc, i.e. a lower part, and an upper half disc, i.e. an upper part, located on said lower half disc, wherein the surface of said upper half disc provides said substrate surface, said upper half disc is made of a conductive material, in particular conductive polymer, and said electrical contact is provided between said upper half disc and said measuring element. In this case, it may not be necessary that a conductive coating/layer is provided on said mass storage media, because the upper half disc is already conductive itself.

The array of measuring elements suitable to be received by a mass spectrometry target substrate, comprises a plurality of measuring element bodies manufactured from a conductive measuring element material. Said bodies are interconnected by a frangible portion of conductive measuring element material, and said measuring element bodies comprise a surface with a measuring coating. Said measuring coating comprises a hydrophilic layer located on said measuring bodies, and said measuring coating further comprises a hydrophobic layer located on said hydrophilic layer. Further, said hydrophobic layer covers said hydrophilic layer only partly, such that the non-covered area of said hydrophilic layer forms a hydrophilic area on said measuring element surface.

The method of manufacturing a mass spectrometry target assembly for accommodating, i.e. receiving at least one analyte for analysis by mass spectrometry comprises: providing a target substrate having a substrate surface, providing at least one measuring element as a separate component from said target substrate, securing or fixing said measuring element on said substrate surface, wherein an electrical contact is formed between said measuring element and said target substrate and/or said substrate surface, i.e. said measuring element and said target substrate and/or said substrate surface are electrically connected.

It is, thus, one aspect to provide a target substrate and at least one measuring element as separate and/or independent components from each other and process each component, i.e. said target substrate and said measuring element separately from each other. Therefore, a wide range of materials can be used for said target substrate completely independent from any processing of said measuring element. In particular, a cheap material may be selected for said target substrate, whereas an expensive material may be chosen for said measuring element, such as titanium or nickel. Because said measuring element is relatively small compared to said target substrate, e.g. a measuring element is typically of a round form with a diameter of 3 mm, only little amounts of said expensive material for said measuring element may be needed. Therefore, production cost can be reduced.

Further, because said measuring element and said target substrate are processed and/or fabricated separately from each other, a coating for the surface of said measuring element can be provided on said measuring element without any interference with said target substrate.

Regarding said method of manufacturing, said measuring element comprises a measuring element surface, and said step of providing said measuring element comprises a step of providing a measuring coating or measuring layer for said measuring element surface, wherein said coating is adapted to or selected to be compatible with a specific type of analyte. In other words, a coating can be freely selected from a wide range of different coatings, each adapted to a specific type of analyte.

Further, said step of providing said target substrate comprises a step of providing a substrate coating for said substrate surface, which substrate coating is different from said measuring coating. In particular, said substrate coating may be a hydrophobic and/or conductive coating, whereas said measuring coating is at least partly a hydrophilic and/or conductive coating.

Further, said step of providing said measuring element comprises the following steps: providing a measuring element body having a measuring element body surface, providing a hydrophilic layer, in particular a nano-crystalline diamond layer, on said measuring element body surface covering said measuring element body surface at least partly. Said measuring element body is can be made of titanium or nickel, thus, allowing manufacturing of said nano-crystalline diamond layer using high temperatures.

Further, said step of providing said measuring element further may comprise a step of providing a hydrophobic layer, in particular a hydrophobic organic layer, on said hydrophilic layer, wherein said hydrophobic layer covers said hydrophilic layer only partly, such that the non-covered area of said hydrophilic layer forms a hydrophilic area on said measuring element surface. Another possibility of creating hydrophilic center surrounded by hydrophobic area directly in mentioned nanocrystalline diamond layer is changing the hydrogen termination to oxygen termination in the desired area.

In some embodiments, said step of fixing said measuring element is a step of adhering said measuring element to said target substrate using an adhesive. In particular, a conductive adhesive may be used providing said electrical contact. Conductive adhesive is thereby applied to the bottom of said measuring element body and/or to said substrate surface.

Further, said measuring element has a certain measuring element shape, and said step of providing said target substrate comprises the following steps: providing at least one recess within said substrate surface wherein said recess has a recess shape corresponding to said measuring element shape, and inserting said measuring element at least partly into said recess.

By fitting said measuring element into said recess, an interference fit may be realized, i.e. said method comprises providing an interference fit, thereby fixing said measuring element in said recess.

Further, within said step of providing at least one measuring element, at least two different measuring elements are provided, wherein each different measuring element is adapted to a specific type of analyte. This means, said method comprises a selecting step in which a measuring element having a certain type of coating is selected in correspondence with a specific type of analyte. Because that measuring element and said target substrate are different components, it is also possible to detach said measuring elements from said target substrate after performing mass spectrometry for a certain set of measuring elements. After said measuring element is detached, i.e. taken away from said target substrate, said target substrate may be reused for a new mass spectrometry analysis with different measuring elements. In some embodiments, said measuring element may be made of magnetic material like nickel and held on the substrate surface by magnetic force.

Due to the separate manufacturing of said measuring elements and said target substrate, i.e. measuring spot holder, it is possible to attach measuring elements pre-treated in different ways to the surface of one target substrate or measuring card. When mass spectrometry is used as a method of disease diagnostics, it is, thus, possible to manufacture multi-diagnosis cards allowing diagnosing multiple diseases on one target.

The invention further provides a method of manufacturing an array of measuring elements suitable to be received by a mass spectrometry target substrate, comprising the steps of providing said array comprising a plurality of measuring element bodies manufactured from a conductive measuring element material, which bodies comprise a surface, wherein said bodies are interconnected by a frangible portion of conductive measuring element material. Further said method comprises: providing a hydrophilic layer on said surface of said bodies, and providing a hydrophobic layer on said hydrophilic layer, wherein said hydrophobic layer covers said hydrophilic layer only partly, such that the non-covered area of said hydrophilic layer forms a hydrophilic area on said measuring element surface.

The invention further provides a sample holder for holding at least one sample comprising: a sample holder body having a sample holder surface, at least one measuring zone/area or measuring spot located on said sample holder surface, wherein said measuring zone is adapted to holding said sample, and a data storage means adapted to storing information corresponding to said sample and/or measuring results corresponding to said sample. In other words, it is possible to store information representative of and/or derived from an analysis of at least one sample received on a corresponding (at least one) measuring zone. Thus, it is possible to use said sample holder for performing measurements on said sample and obtaining measuring results. These measuring results can be stored directly in said storage means. Therefore, said measuring results are tightly coupled to said samples and cannot be lost or separated from each other. It is, therefore, possible to store the samples, e.g. for later re-measurements or checking of sample type or the like, together with already obtained measuring results.

In some embodiments, said sample holder is a mass storage media, e.g. a standard mass storage media, in particular a CD, CD-R/RW, DVD, DVD-R/RW, Blu-Ray Disc or the like, said sample holder surface is the surface of said mass storage media, and said storage means is provided by said mass storage media. In other words, a standard CD, CD-R/RW, DVD, DVD-R/RW, Blu-Ray Disc or the like can be modified according to the invention to function as a sample holder. Because e.g. a mass storage means may be used, large amounts of measuring data may be stored on said storing means.

In a further embodiment, said measuring spot may be provided as a measuring element as a different component from said sample holder body, wherein said measuring spot/element is fixed to said sample holder body. Said measuring spot/element then may have the same structure as the above defined measuring element, e.g. with respect to the type of coating and/or different layers and so on.

Further, said sample holder may comprise an electrically conductive layer located on said sample holder body and providing said sample holder surface, and an electrical contact between said measuring spots and said conductive layer. Said electrical contact is e.g. important when using said sample holder for mass spectrometry for surface charge dissipation.

In some embodiments, said measuring spot is fixed to said sample holder surface using conductive adhesive.

Said sample holder may comprise an upper region providing said sample holder surface and made from an electrically conductive material. In this case said measuring spots may be provided integrally with said sample holder body. This means, the measuring spot may be fabricated by sputtering or the like directly on said sample holder surface. In this case, the layer should be hydrophilic and additional hydrophobic layer can be provided to achieve sample pre-concentration effect as described earlier. Possible methods: screen or tampon printing, etc.

Said sample holder further may be a standard DVD comprising a lower half disc, and an upper half disc located on said lower half disc, wherein the surface of said upper half disc provides said sample holder surface, and said upper half disc is made of a conductive material, in particular conductive polymer. In other words, the upper half disc of a standard DVD is substituted by (or fabricated as) a conductive upper half disc. This way the upper half disc can be processed in order to provide said measuring spots and be used as a sample holder.

Said sample holder further may comprise at least two different measuring spots, each adapted to a different type of sample or analyte. All above-mentioned embodiments with respect to using different measuring elements are then of course likewise applicable.

Said sample holder may have a rectangular shape, enabling an easy storage of said sample holder. In particular, said sample holder may have a card shape.

Further, a method of manufacturing a sample holder is provided, comprising the following steps: providing a mass storage media having a conductive mass storage media surface, providing a measuring element as a separate component from said mass storage media, fixing said measuring element on said mass storage media surface.

In one embodiment, said method of manufacturing a sample holder comprises the following steps: providing a standard mass storage media having a mass storage media surface, providing an electrically conductive coating on said mass storage media surface, providing a measuring element as a separate component from said mass storage media, fixing said measuring element on said mass storage media surface. In other words, a standard mass storage media, such as e.g. a standard CD-R/RW or DVD-R/RW, i.e. a standard CD or DVD or future optical storage media formats, e.g. Blue-Ray Disc, may be used, and a conductive coating is provided on this standard mass storage media, such as e.g. a metal layer fabricated e.g. by sputtering. Said measuring elements are then fixed to this conductive coating on said standard mass storage media, e.g. by using conductive adhesive.

In another embodiment, said method of manufacturing a sample holder comprises the following steps: providing a lower half disc of a DVD, providing an upper half disc of said DVD made of conductive material, which upper half disc has an upper half disc surface, joining said lower half disc and said upper half disc, in order to obtain a complete DVD, wherein the surface of said DVD is said upper half disc surface, providing a measuring element as a separate component from said lower and upper half discs, and fixing said measuring element on said upper half disc surface. In other words, the manufacturing of a standard DVD is modified, such that the upper half disc is made of electrically conductive material. This way, the DVD can be used as substrate holder. In this case, it may not be necessary to provide an electrically conductive coating additionally, because the surface of the sample holder is already conductive itself. It is also possible, that within this embodiment, an electrically conductive coating is provided. In other words, the steps of the two embodiments for manufacturing a sample holder may be combined in any order without any limitations.

The invention and details thereof will be explained by way of an exemplary embodiment thereof the following with reference to the accompanying drawings, in which

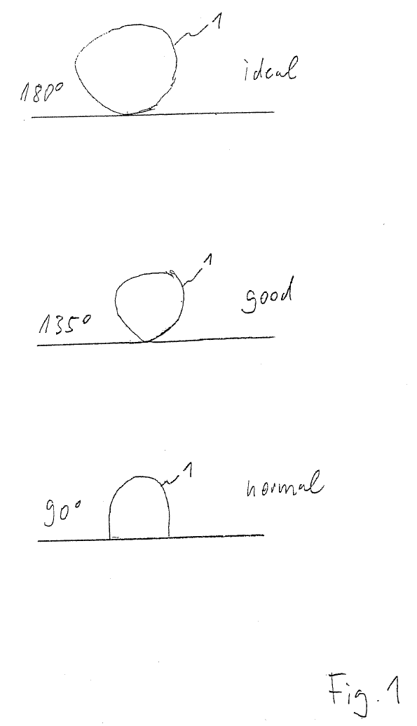

FIG. 1 shows fluid samples under different conditions;

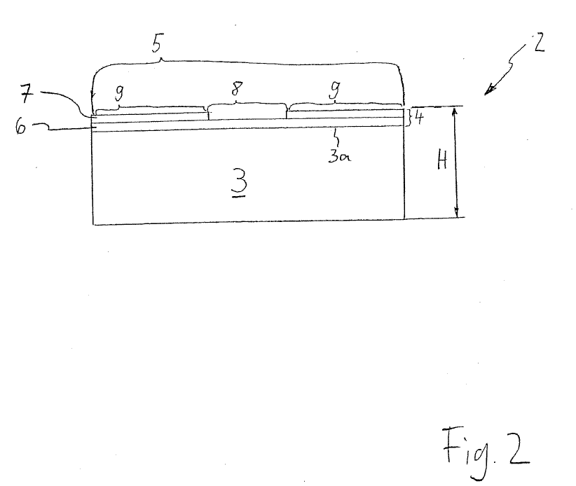

FIG. 2 shows a sectional view of a measuring element;

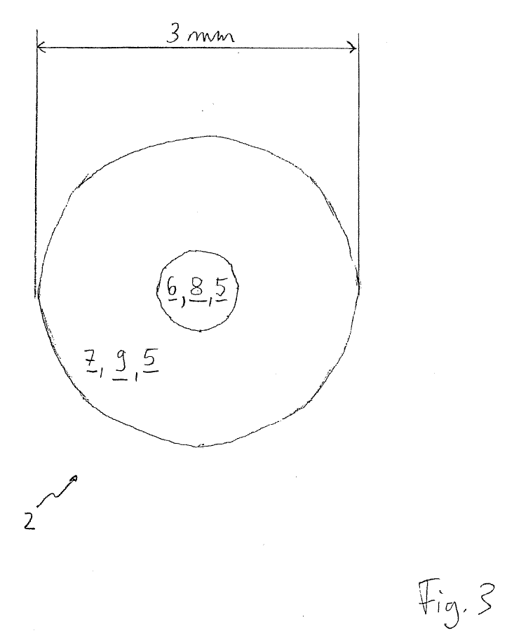

FIG. 3 shows a top view of said measuring element;

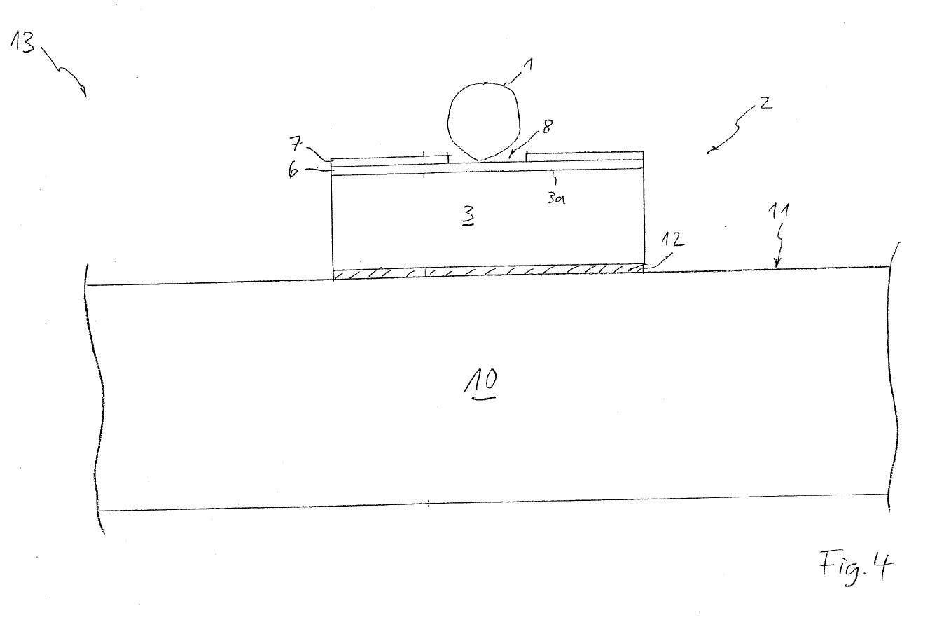

FIG. 4 shows a measuring element fixed on a target substrate;

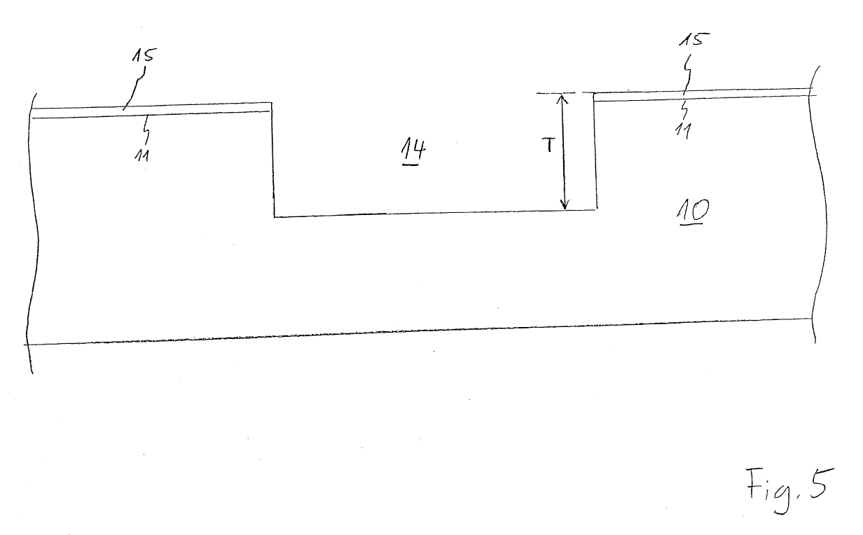

FIG. 5 shows a sectional view of the target substrate without measuring element;

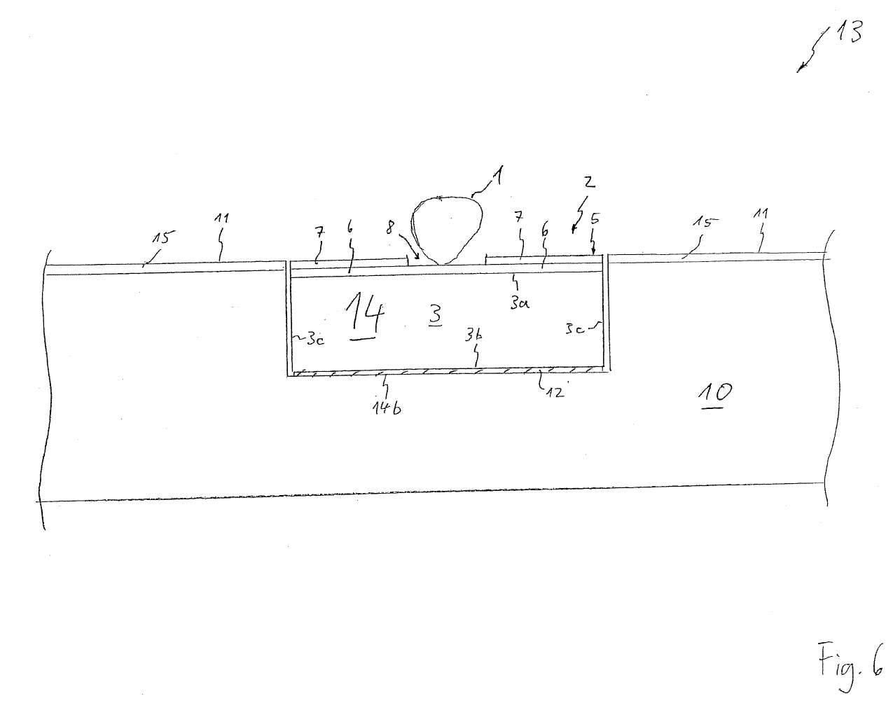

FIG. 6 shows a sectional view of the target substrate together with a measuring element;

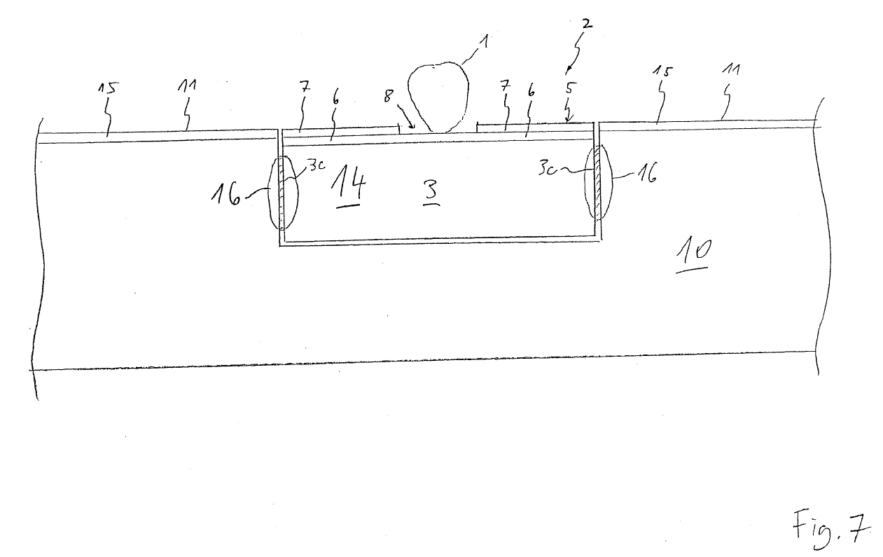

FIG. 7 shows a sectional view of said target substrate and said measuring element fixed with an interference fit;

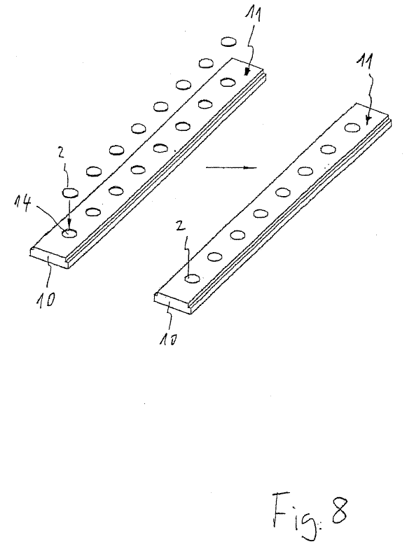

FIG. 8 shows a perspective view before and after fixing said measuring elements to said target substrate;

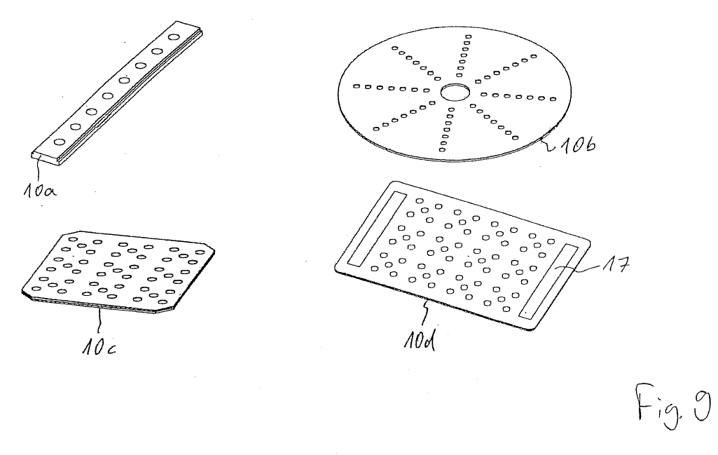

FIG. 9 shows different shapes of said target substrate;

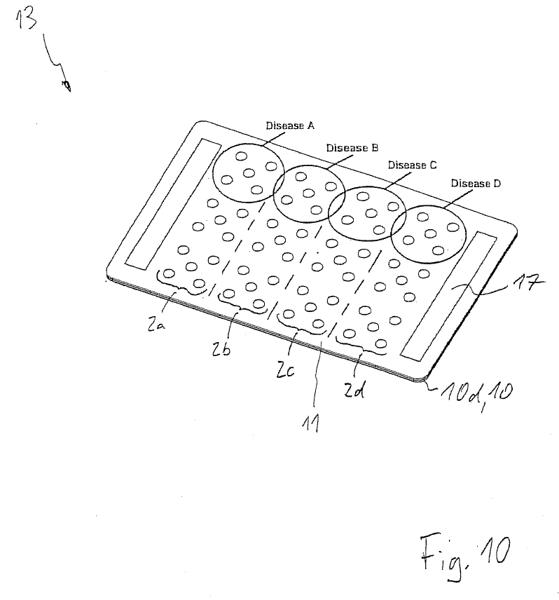

FIG. 10 shows different measuring elements on the same target substrate;

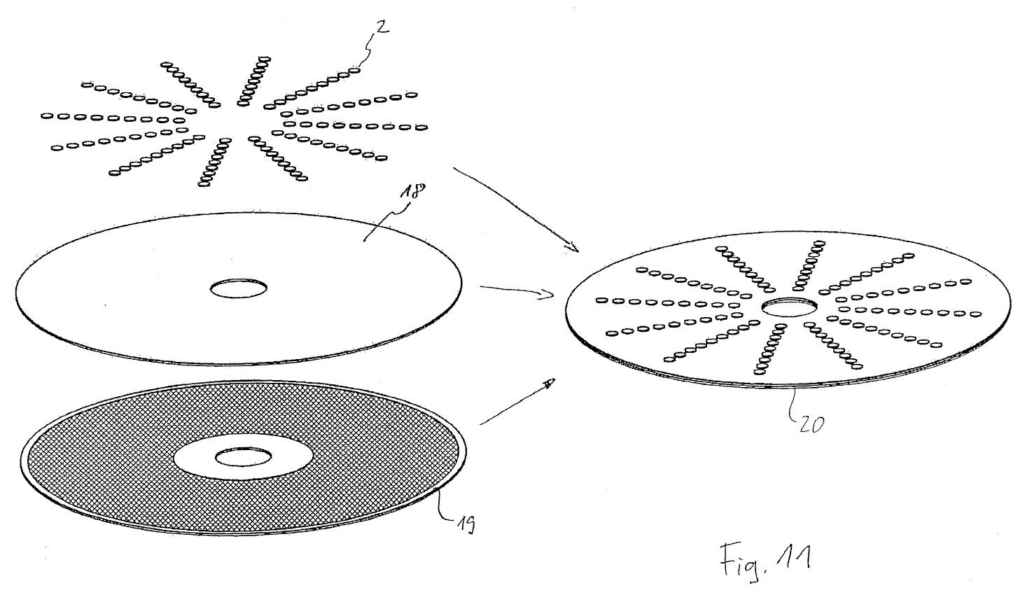

FIG. 11 shows a perspective view before and after assembling of a sample holder DVD;

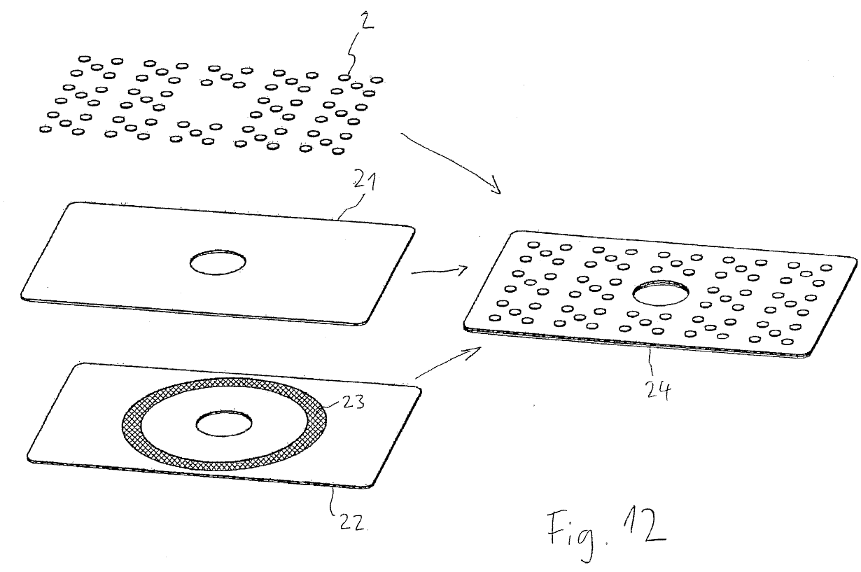

FIG. 12 shows a perspective view before and after assembling of a card-shaped sample holder;

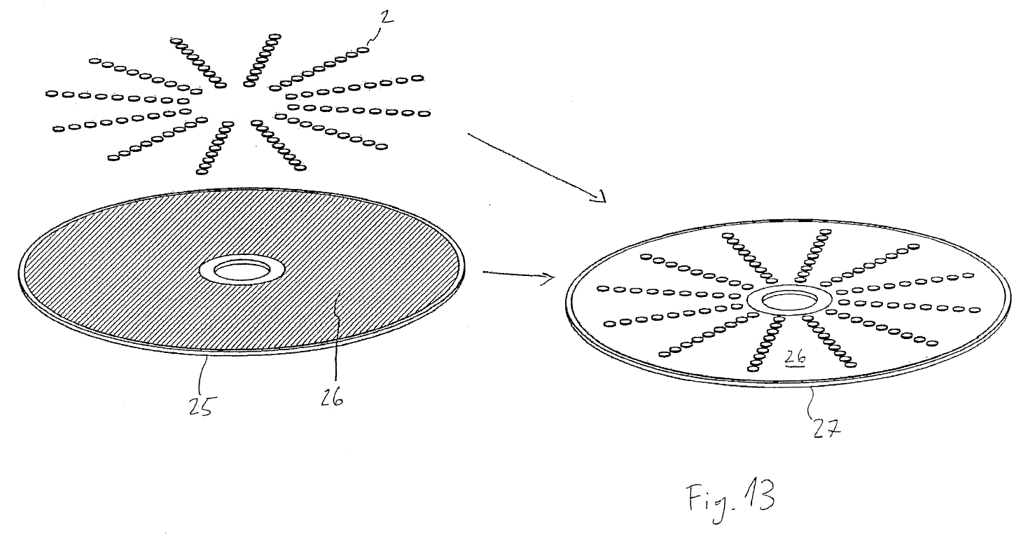

FIG. 13 shows a perspective view before and after assembling of a sample holder CD; and

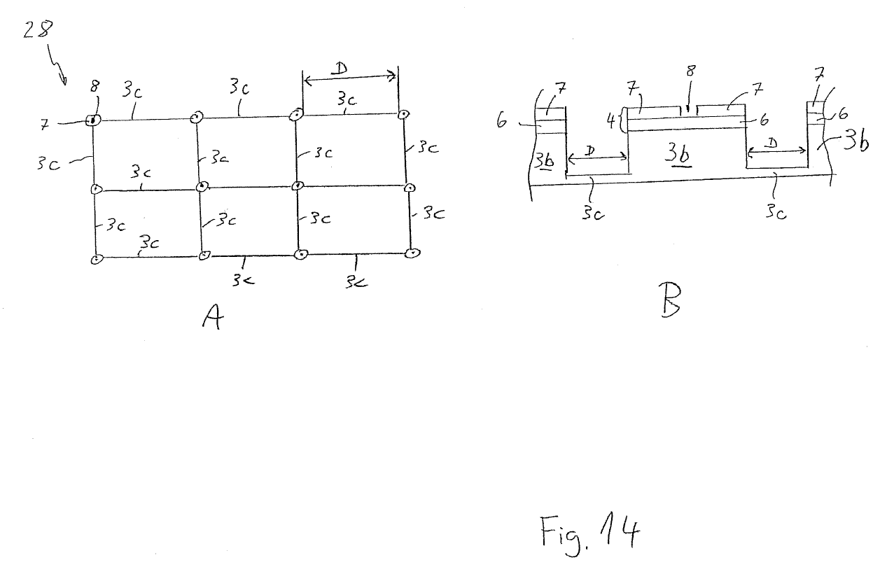

FIG. 14 shows an array of measuring elements.

In FIG. 1, an analyte 1, e.g. a fluid sample, to be used for mass spectrometry or mass spectroscopy is shown under different conditions. The view on top of FIG. 1 shows said analyte 1 under ideal conditions, wherein the tangent of said analyte 1 forms an angle of 180° with the surface on which said analyte lies. The view in the middle of FIG. 1 shows said analyte 1 on a different surface, wherein the tangent at the bottom of said analyte 1 forms an angle of 135° with the surface. This is considered to be a good condition for mass spectrometry. The bottom view of FIG. 1 shows said analyte 1 under normal conditions, wherein the tangent on said analyte 1 forms an angle of 90° with the surface on which said analyte 1 lies.

FIG. 2 shows a sectional view of a measuring element 2, i.e. a measuring spot on which said analyte 1 may be placed when said measuring element 2 is used for mass spectrometry. Said measuring element 2 comprises a measuring element body 3 having a measuring element body surface 3a. Further, said measuring element 2 comprises a measuring coating 4 on its surface 5. Said measuring coating 4 is located on said measuring element body surface 3a.

Said measuring coating 4 comprises a hydrophilic layer 6 located on said measuring element body surface 3a. Said hydrophilic layer 6 covers said measuring element body surface 3a completely, however, in another embodiment it may also only cover parts of said measuring element body surface 3a. Said measuring coating 4 further comprises a hydrophobic layer 7 located on said hydrophilic layer 6. Said hydrophobic layer 7 covers said hydrophilic layer 6 only partly, thus, providing for a hydrophilic area 8 in the middle of said surface 5 of said measuring element 2. Around said hydrophilic area 8, a hydrophobic area 9 is provided by said hydrophobic layer 7. When an analyte is accommodated or placed on said measuring element 2, said analyte, in particular a fluid sample, will be held within said hydrophilic area 8, in particular under good conditions as outlined above in connection with FIG. 1.

FIG. 3 shows a top view of said measuring element 2 having a round shape. Typically the diameter is approximately 3 mm. Of course, said measuring element 2 may have any other shape such as e.g. quadratic, rectangular or oval. As can be seen in FIG. 3, on said measuring element surface 5, said hydrophilic layer 6 and said hydrophobic layer 7 provide said hydrophilic area 8 and said hydrophobic area 9, respectively.

FIG. 4 shows a first embodiment of the invention. In particular, a target substrate 10 having a substrate surface 11 is shown. Said target substrate 10 may be e.g. made of conductive polymer based substrate. However, any other material may be used.

In said first embodiment of FIG. 4, said measuring element 2 is fixed on said substrate surface 11 using an adhesive 12, in particular a conductive adhesive, thus providing for an electrical contact between said measuring element 2 and said target substrate 10 or said substrate surface 11. Said measuring element 2 and said target substrate 10 provide a mass spectrometry target assembly 13, wherein the complete mass spectrometry target assembly in general comprises a plurality of measuring elements 2.

When in use, said analyte 1 is held on said measuring element 2, in particular within said hydrophilic area 8 as shown in FIG. 4.

FIGS. 5 and 6 show a second embodiment of the invention. FIG. 5 shows a sectional view of a target substrate 10 with a substrate coating 15 on its substrate surface 11. Said substrate coating 15 may be e.g. a hydrophobic coating, in particular an organic hydrophobic coating or layer. If the material of target substrate 10 is hydrophobic itself, hydrophobic coating 15 may not be necessary.

Said target substrate 10 comprises a recess 14 having the same shape as said measuring element 2, i.e. when said measuring element 2 has a round shape as shown in FIG. 3, then said recess 14 also has a corresponding round shape. Thereby, the depth T of said recess 14 corresponds to the height H of said measuring element 2 as indicated in FIGS. 2 and 5, respectively.

According to the second embodiment, said measuring element 2 is inserted into said recess 14 as shown in FIG. 6. Said measuring element 2 is inserted completely into said recess 14, such that said measuring element surface 5 is on the same level as said substrate surface 11, i.e. said measuring element 2 does not project from said substrate surface 11. This can be important when using said mass spectrometry target assembly 13 in certain devices for mass spectrometry.

In the second embodiment of FIGS. 5 and 6, said measuring element 2 is fixed in said recess 14 using an adhesive 12, in particular an electrically conductive adhesive. Thus, said adhesive 12 is e.g. applied to the bottom 3b of said measuring element body or on the bottom 14b of said recess 14. This means, said adhesive 12 lies between said bottom 3b of said measuring element body 3 and said bottom 14b of said recess 14. Said adhesive 12 may also be applied to the side faces 3c of said measuring element body 3, thus, improving the electrical contact between said measuring element 2 and said target substrate 10.

FIG. 7 shows a third embodiment of the invention wherein said measuring element 2 is also inserted into said recess 14. However, said measuring element 2 is not fixed by an adhesive, but by an interference fit 16. In order to realize said interference fit 16, the shape of said measuring element 2 should match closely with the shape of said recess 14. In this third embodiment of FIG. 7, the electrical contact between said measuring element 2 and said target substrate 10 is realized by said interference fit, i.e. the two components i.e. the measuring element 2 and the target substrate 10 contact each other.

FIG. 8 corresponds to the second and third embodiment, where said target substrate 10 comprises recesses 14, i.e. notches or wells, in which a plurality of measuring elements 2 are inserted. The left hand side of FIG. 8 shows said measuring elements 2 before insertion into said recesses 14, and the right hand side of FIG. 8 shows said measuring elements 2 after insertion.

FIG. 9 shows different shapes 10a to 10d of said target substrate 10. As seen in FIG. 9, a rectangular shape 10a, a round shape 10b, a plate-like shape 10c and a card shape 10d are possible as examples. When using a card shape 10d, fields 17 for labels may be provided.

FIG. 10 shows a fourth embodiment of the invention. In this fourth embodiment said target substrate 10 is of a card shape 10d. Further, said substrate surface 11 holds different measuring elements 2a, 2b, 2c and 2d. Said measuring elements 2a to 2d differ in the type of measuring coating each adapted to a specific type of analyte. When the mass spectrometry target assembly 13 according to said fourth embodiment is used in mass spectrometry for diagnosing diseases, said different measuring elements 2a to 2d correspond to different diseases to be diagnosted, i.e. to diseases A to D.

In case a plurality of measuring elements 2 is provided on said target substrate 10, one or more of said measuring elements 2 may be adapted to serving as calibrating spots. Measuring elements 2 serving as calibrating spots may have the same or a different coating from the rest of said measuring spots 2 depending on the method used for mass spectrometry.

FIG. 11 shows a perspective view before and after assembling of a sample holder DVD 20 on the left and right side of FIG. 11, respectively.

The sample holder DVD 20 is an example of the inventive sample holder comprising a lower half disc 19. Said lower half disc 19 comprises a recordable layer determining disc storage capacity. For example, a recordable layer with storage capacity of 4.7 GB is used.

Said sample holder DVD 20 further comprises an upper half disc 18 to be joined or fixed to said lower half disc 19. Both half discs have a thickness of 0.6 mm, such that when bonded together the complete DVD is 1.2 mm thick.

In one embodiment, said upper half disc 18 may be made of a conductive material, e.g. conductive polymer-based material. In this case, measuring spots 2 may be attached directly on the surface of said upper half disc 18 wherein an electrical contact is provided between said measuring elements 2 and said upper half disc 18, e.g. by applying conductive adhesive. Therefore, the complete sample holder DVD 20 can e.g. be used for mass spectrometry requiring that an electrical contact is provided between said measuring elements 2 and said upper half disc 18.

In another embodiment it is also possible that said upper half disc 18 comprises a body made from non-conductive material, and a conductive coating or layer is provided on its surface. Again, this way the complete sample holder DVD 20 can be used for mass spectrometry.

In case said upper half disc 18 is made of conductive material, in a further embodiment, measuring spots may be provided integrally with said upper half disc 18 (not shown). In other words, said upper half disc 18 may be a target substrate with integrated measuring spots, wherein the target substrate has the shape corresponding to a standard upper half disc of a DVD, i.e. in this embodiment measuring spots are not separate components and therefore not fabricated separately from said upper half disc 18 but integrally. The respective sample holder DVD may therefore simply be fabricated by providing a lower half disc of a standard DVD, and providing a target substrate with measuring spots in the form of an upper half disc of said DVD, which is made of conductive material, and joining said lower half disc and said upper half disc, in order to obtain a complete DVD.

In all shown emboidments of the invention, the surface of the mass spectrometry target assembly/sample holder has a conductive surface in order to allow for surface charge dissipation during mass spectrometry measurement.

FIG. 12 shows a perspective view of a further embodiment of the invention, wherein a card-shaped target substrate 21 is joined with a card-shaped CD-R/RW 22 that comprises a recordable region 23. Said card-shaped CD-R/RW 22 may be fitted into a standard CD-drive or into a modified optical drive that may be necessary due to higher thickness of the assembly.

In the embodiment of FIG. 12, said measuring elements 2 are fixed to said card-shaped target substrate 21. Further, said card-shaped target substrate 21 is joined together with said card-shaped CD-R/RW 22. The result is a card-shaped sample holder 24 comprising a storage means provided by said card-shaped CD-R/RW 22. It is also possible to manufacture said card-shaped CD-R/RW 22 by subsequent shaping of a disc.

In the embodiments of FIGS. 11 and 12, separately prepared sample spots are used, i.e. measuring elements, that are diamond-coated thin round plates made of material withstanding coating process conditions or any other spots which can be used as sample presentation surface for mass spectrometry. Said sample spots are fixed with conductive adhesive, e.g. acrylic adhesive filled with carbon black to the top surface of the 1.2 mm thick DVD 20 consisting of said two 0.6 mm half discs. The upper half disc to which the sample spots are fixed is either electrically conductive itself (in which case the surface resistance is <2 kOhm), i.e. made of conductive polymer, e.g. filled polycarbonate, or coated with conductive layer, e.g. consisting of sputtered metal or diamond-like carbon. The lower half disc, i.e. the bottom half disc is a standard DVD recordable layer with storage capacity of 4.7 GB for storing measured data or any additional user information. Said measuring spots can be arranged in any pattern, conveniently using arrangements and distances common in microtiter plates (4.5 mm or 9 mm) enabling usage of automated spotting systems. Some of said measuring spots (elements) may be prepared as calibration spots (lock mass) carrying mass standards for calibrating measuring equipment. A mass spectrometry target according to the invention can also be shaped in any convenient shape, e.g. rectangular as described in connection with FIG. 12. When using a card-shaped CD-R/RW 22 as in FIG. 12, storage capacity is approximately 500 MB.

FIG. 13 shows a perspective view before and after assembling of a sample holder CD 27 on the left hand side and right hand side of FIG. 13, respectively.

On the left hand side of FIG. 13, a standard CD-R/RW 25 is shown, on which a conductive coating 26, e.g. a sputtered metal layer or the like, is provided. In other words, in this embodiment of the invention, a standard CD is used, and a conductive layer/coating 26 is provided on its surface.

On said conductive coating 26, said measuring elements 2 are attached, i.e. fixed, e.g. with a conductive adhesive, or manufactured integrally with the layer. An additional hydrophobic layer can or should be provided.

The embodiment of FIG. 13, therefore, shows a very cheap way of manufacturing a sample holder comprising a storage means, which is provided by a standard CD-R/RW. Of course, instead of a CD-R/RW a standard DVD-R/RW may also be used, or any other storage media. For example, it is also possible to use a card with an RF-ID tag, on which a conductive layer is provided.

Also, in the embodiment of FIG. 12, instead of said card-shaped CD-R/RW 22, of course, any other storage means with a given shape may be used. For example, the target substrate may be bonded with a card equipped with a magnetic stripe, RF-ID tag or memory chip. In other words, said storage means is provided by a magnetic stripe, RF-ID tag or memory chip. In each case for archiving and later-re-measurements, measured data can be stored directly on the target providing inseparable relation between target and data. In case of using RF-ID technology, a wireless data transfer is possible. If a storage means with a conductive surface is used, according to the invention, measuring elements and/or calibrating spots/elements may be attached directly to the surface of said storage means.

FIG. 14 shows an array of measuring elements 28, wherein the measuring elements are suitable to be received by a mass spectrometry target substrate. Said array 28 comprises a plurality of measuring element bodies 3b manufactured from a conductive measuring element material. Said bodies 3b are interconnected by a frangible portion 3c of conductive measuring element material, as can be seen in FIG. 14B that shows a part of a side view of said array.

Said measuring element bodies 3b comprise a surface with a measuring coating 4, wherein said measuring coating 4 comprises a hydrophilic layer 6 located on said measuring bodies 3b. Said measuring coating 4 further comprises a hydrophobic layer 7 located on said hydrophilic layer 6. Said hydrophobic layer 7 covers said hydrophilic layer 6 only partly, such that the non-covered area of said hydrophilic layer 6 forms a hydrophilic area 8 on said measuring element surface 5.

For obtaining measuring elements to be received by a target substrate for mass spectrometry, said frangible portions 3c can be broken or cut off e.g. by hand.

The following elucidations may be helpful to understand the invention or details thereof.

Conventional targets for MALDI/SELDI mass spectroscopy or mass spectrometry are based on substrates of various shapes and are made of wide selection of materials. Usually, substrate surface is coated with a hydrophobic layer surrounding hydrophilic spots that are the actual sample presentation areas and are usually treated with various chemicals depending on type of analysis. In case that manufacturing processes or chemicals used for sample area pre-treatment are not compatible with the target substrate, which is in particular e.g. the case when using chemical vapour deposition (CVD) diamond layer as sample presentation surface, i.e. as measuring spots, it is not possible to manufacture the target if the target is polymer-based. This is, because in order to provide for a diamond coating said target must be heat-resistant.

Therefore, the invention teaches to separate the process or manufacturing of an MS (=mass spectrometry) target into an assembly consisting of different components, wherein one component is a sample presentation spot, i.e. a measuring element/spot and another component is a holder, i.e. a target substrate, to which one or a plurality of said spots, i.e. measuring elements, are attached or fixed. The attachment may be realized mechanically or using an electrically conductive adhesive. Thereby, a large flexibility in MS target configuration design is realized, i.e. sample presentation spots in form of small circular plates with a diameter of a few millimeters and a thickness of a few tens of millimeters are manufactured. Thereby, suitable materials may be used for said spots and said spots are processed completely independent, i.e. separately from the holder, i.e. said target substrate. The target substrate can also be made of different suitable materials that can be chosen independently from the material of said spots. Said target substrate can be of an arbitrary shape.

In prior art, conventional MALDI mass spectrometry targets consist of a substrate (holder) made of suitable material, e.g. steel, coated with a hydrophobic layer surrounding hydrophilic areas of circular shape. MS targets made of hydrophobic conductive plastic with circular matrix spots are usually used as economical disposable targets. In both cases, the circular areas are the actual sample presentation spots. The purpose of the hydrophobic areas is to retain the analyte solution in sample presentation spots and to pre-concentrate substances contained in said analyte solution on a small area. Due to pre-concentration, the sensitivity of the measurement can be increased.

In case of SELDI targets, the surface of the sample presentation spots is usually treated with various chemicals necessary for a given type of analysis for achieving selective affinity to various substances, e.g. proteines or peptides, to be analyzed.

To increase the sensitivity of MALDI or SELDI measurements, various surfaces, i.e. various different coatings may be used for the measuring coating. The spot surface, i.e. the measuring element surface is therefore coated or treated with various chemicals necessary for a given type of analysis. According to the invention, it is possible to choose almost arbitrary a substrate material and a suited material for the measuring elements, which can be processed or treated with chemicals or pre-treated in order to manufacture a desired measuring element having a suited type of coating for a given type of analysis. Therefore, said measuring element may be e.g. coated with nano-crystalline chemical vapour deposition (CVD) diamond affinity layer where the coating process temperature reaches 700 to 800° C. In prior art, for this reason, there was a fairly narrow selection of suitable materials for diamond coating and at the same time due to MS method requirements, suitable as sample presentation surface for MS spectrometry. In particular, in prior art, conductive, polymer-based disposable substrates cannot be used for diamond coating due to a low thermal resistance. In prior art, when a diamond coating should be realized, targets, i.e. target substrates needed to have a high thermal resistance, as e.g. titanium or nickel. However, when choosing titanium or nickel as substrate material, production cost is very high, in particular, when coating the whole target substrate with a diamond coating.

Because said measuring elements are fabricated separately from said target substrate, any suitable electrical conductive material may be used for said target substrate, e.g. metal, conductive plastic, composite material or sandwich. Said measuring elements may be made of any material compatible with an applied measuring method. The material chosen for said measuring element may depend on the applied measuring method and may be pre-treated or coated with various materials or chemicals. After the production process of said measuring element, said measuring elements with a diameter of a few millimeters and a thickness of several tens of millimeters are attached to said target substrate either mechanically by pressing, i.e. by an interference fit, or with conductive adhesive. Wells with a depth equal to spot plate thickness, can be provided on the top substrate surface, i.e. on the substrate surface for easier positioning and for achieving the same height of substrate and spots.

The invention provides, thus, among others, the following advantages:
A broader selection of construction materials for MS target substrates as well as for the measuring elements enable a better adjustment of target properties to analytical method requirements for various analytes.
It is possible to combine almost any kind of material for said target substrate with a material for said measuring element that is compatible with the manufacturing process applied to said measuring element. The material chosen for said measuring element can in particular be chosen to be compatible with chemical or physical properties that need to be met when providing said measuring coating. In particular, as target substrate a plastic target substrate may be used, whereas as measuring coating a diamond layer is used.
Also, as shown and described in connection with FIG. 10, it is possible to combine various different measuring spots on one target, and, thus, it is possible to fabricate multi-analytical targets.

### REFERENCE SYMBOLS

1 analyte
2 measuring element
3 measuring element body
3a measuring element body surface
4 measuring coating
5 measuring element surface
6 hydrophilic layer
7 hydrophobic layer
8 hydrophilic area
9 hydrophobic area
10 target substrate
11 substrate surface
12 adhesive
13 mass spectrometry target assembly
14 recess
15 substrate coating
16 interference fit
17 field for labels
18 upper half disc
19 lower half disc
20 sample holder DVD
21 card-shaped target substrate
22 card-shaped CD-R/RW
23 recordable region
24 card-shaped sample holder
25 standard CD-R/RW
26 conductive coating
27 sample holder CD

1. Mass spectrometry target assembly for receiving at least one analyte (1) for analysis by mass spectrometry comprising:
a target substrate (10) having a substrate surface (11),
at least one measuring element (2),
wherein
said target substrate (10) and said measuring element (2) are distinct components,
said measuring element (2) is secured to said substrate surface (11), and wherein
said measuring element (2) is electrically connected to (12,16) to said target substrate (10) and/or said substrate surface (11).

2. Mass spectrometry target assembly according to claim 1, characterized in that
said measuring element (2) comprises a measuring element surface (5), and
said measuring element surface (5) comprises a measuring coating (4) adapted to a specific type of analyte (1).

3. Mass spectrometry target assembly according to claim 1 or 2, characterized in that
said measuring element (2) comprises or is at least in part made from a conductive measuring element material, and
said target substrate (10) comprises or is at least in part made from a conductive substrate material.

4. Mass spectrometry target assembly according to any one of the preceding claims, characterized in that
said substrate surface (11) comprises a conductive substrate coating, wherein said measuring element (2) and said substrate coating are electrically connected.

5. Mass spectrometry target assembly according to any one of claims 2 to 4, characterized in that
said measuring coating (4) extends over at least part of the measuring element surface and is a hydrophilic coating.

6. Mass spectrometry target assembly according to any one of claims 2 to 5, characterized in that
said measuring coating (4) comprises a nano-crystalline diamond coating, and/or
said measuring element material is selected from the group of materials consisting of titanium and nickel.

7. Mass spectrometry target assembly according to any one of claims 2 to 6, characterized in that
said measuring element (2) comprises a measuring element body (3),
said measuring coating (4) comprises a hydrophilic layer (6) located on said measuring body,
said measuring coating (4) further comprises a hydrophobic layer (7) located on said hydrophilic layer (6),
wherein
said hydrophobic layer (7) covers said hydrophilic layer (6) only partly, such that the non-covered area of said hydrophilic layer (6) forms a hydrophilic area (8) on said measuring element surface (5).

8. Mass spectrometry target assembly according to claim 7, characterized in that
said hydrophilic layer (6) is a nanocrystalline diamond layer and/or
said hydrophobic layer (7) is a hydrophobic organic layer.

9. Mass spectrometry target assembly according to any one of the preceding claims, characterized in that
said measuring element (2) is fixed to said substrate surface (11) by a conductive adhesive (12).

10. Mass spectrometry target assembly according to any one of the preceding claims, characterized in that
said measuring element (2) is mechanically fixed to said substrate surface (11).

11. Mass spectrometry target assembly according to any one of the preceding claims, characterized in that
said measuring element (2) has a measuring element shape,
said target substrate (10) has at least one recess (14) formed within said substrate surface (11),
wherein
said recess (14) has a recess shape corresponding to said measuring element shape, and
said measuring element (2) is at least partly inserted into said recess.

12. Mass spectrometry target assembly according to claim 11, characterized in that
said measuring element (2) is fixed in said recess (14) by an interference fit.

13. Mass spectrometry target assembly according to any one of the preceding claims, characterized in that
said assembly comprises at least two different measuring elements (2a-2d), each having a different measuring coating (4) each adapted to a different type of analyte (1).

14. Mass spectrometry target assembly according to any one of the preceding claims, characterized in that
said target substrate (10) is a mass storage media, and
said substrate surface (11) is a surface of said mass storage media.

15. Mass spectrometry target assembly according to claim 14, characterized in that
said mass storage media is an optical disc (20,22,27) to which data can be written.

16. Mass spectrometry target assembly according to claim 14 or 15, characterized in that
said mass spectrometry target assembly comprises a conductive layer located on said mass storage media, wherein the surface of said conductive layer is said substrate surface (11).

17. Mass spectrometry target assembly according to any one of claims 14 or 16, characterized in that
said mass storage media is a writable or rewritable Digital Versatile Disc (DVD-R/RW) comprising a lower half disc, and an upper half disc located on said lower half disc,
wherein
the surface of said upper half disc provides said substrate surface (11),
said upper half disc is made of a conductive material, and
said upper half disc and said measuring element are electrically connected.

18. An array (28) of measuring elements suitable to be received by a mass spectrometry target substrate, wherein
said array (28) comprises a plurality of measuring element bodies (3b) manufactured from a conductive measuring element material,
said bodies (3b) are interconnected by a frangible portion (3c) of conductive measuring element material,
said measuring element bodies (3b) comprise a surface with a measuring coating (4),
said measuring coating (4) comprises a hydrophilic layer (6) located on said measuring bodies,
said measuring coating (4) further comprises a hydrophobic layer (7) located on said hydrophilic layer (6), and wherein
said hydrophobic layer (7) covers said hydrophilic layer (6) only partly, such that the non-covered area of said hydrophilic layer (6) forms a hydrophilic area (8) on said measuring element surface (5).

19. Method of manufacturing a mass spectrometry target assembly for receiving at least one analyte (1) for analysis by mass spectrometry comprising:
providing a target substrate (10) having a substrate surface (11),
providing at least one measuring element as a distinct component from said target substrate (10),
securing said measuring element on said substrate surface (11), wherein said measuring element and said target substrate (10) and/or said substrate surface (11) are electrically connected.

20. Method according to claim 19, characterized in that
said measuring element comprises a measuring element surface (5), and
said step of providing said measuring element comprises a step of providing a measuring coating (4) for said measuring element surface (5), wherein said coating is adapted to or selected to be compatible with a specific type of analyte (1).

21. Method according to claim 20, characterized in that
said step of providing said target substrate (10) comprises a step of providing a substrate coating for said substrate surface (11), which substrate coating is different from said measuring coating (4).

22. Method according to claim 20 or 21, characterized in that
said measuring coating (4) extends over at least part of the measuring element surface and is a hydrophilic coating.

23. Method according to any one of claims 19 to 20, characterized in that said step of providing said measuring element comprises the following steps:
providing a measuring element body (3) having a measuring element body (3) surface,
providing a hydrophilic layer (6), in particular a nano-crystalline diamond layer, on said measuring element body (3) surface covering said measuring element body (3) surface at least partly.

24. Method according to claim 23, characterized in that
said step of providing said measuring element further comprises a step of providing a hydrophobic layer (7), in particular a hydrophobic organic layer, on said hydrophilic layer (6),
wherein said hydrophobic layer (7) covers said hydrophilic layer (6) only partly, such that the non-covered area of said hydrophilic layer (6) forms a hydrophilic area (8) on said measuring element surface (5).

25. Method according to claim 24, characterized in that
said step of fixing said measuring element is a step of adhering said measuring element to said target substrate (10) using a conductive adhesive.

26. Method according to any one of claims 19 to 24, characterized in that
said measuring element (2) has a certain measuring element shape,
said step of providing said target substrate (10) comprises the following steps:
providing at least one recess within said substrate surface (11), wherein said recess has a recess shape corresponding to said measuring element shape,
inserting said measuring element at least partly into said recess.

27. Method according to claim 26, characterized in that
said step of inserting said measuring element into said recess comprises providing an interference fit, fixing said measuring element in said recess.

28. Method according to any one of claims 19 to 27, characterized in that
within said step of providing at least one measuring element at least two different measuring elements are provided, wherein each different measuring element is adapted to a specific type of analyte (1).

29. Method of manufacturing an array (28) of measuring elements suitable to be received by a mass spectrometry target substrate, comprising the steps of
providing said array (28) comprising a plurality of measuring element bodies (3b) manufactured from a conductive measuring element material, which bodies comprise a surface, wherein said bodies (3b) are interconnected by a frangible portion (3c) of conductive measuring element material,
providing a hydrophilic layer (6) on said surface of said bodies (3b),
providing a hydrophobic layer (7) on said hydrophilic layer (6), wherein said hydrophobic layer (7) covers said hydrophilic layer (6) only partly, such that the non-covered area of said hydrophilic layer (6) forms a hydrophilic area (8) on said measuring element surface (5).

30. Sample holder for holding at least one sample comprising:
a sample holder body (18, 21, 25) having a sample holder surface,
at least one measuring zone (2) located on said sample holder surface, wherein said measuring zone (2) is suitable to receive said sample, and
a data storage means (19, 22, 27) adapted to storing information corresponding to said sample and/or measuring results corresponding to said sample.

31. Sample holder according to claim 30, characterized in that
said sample holder is an optical disc to which data can be written,
said sample holder surface is the surface of said optical disc, and
said data storage means is provided by said optical disc.

32. Sample holder according to claim 30 or 31, characterized in that
said measuring zone (2) is provided by a measuring spot that is a distinct component from said sample holder body, wherein said measuring spot is fixed to said sample holder body.

33. Sample holder according to any one of claims 30 to 32, characterized in that
said sample holder comprises an electrically conducive layer (26) located on said sample holder body and providing said sample holder surface, wherein said measuring spot and said conductive layer are electrically connected.

34. Sample holder according to any one of claims 30 to 33, characterized in that
said measuring spot is fixed to said sample holder surface using conductive adhesive.

35. Sample holder according to any one of claims 30 to 34, characterized in that
said sample holder comprises an upper region (18) providing said sample holder surface and made from an electrically conductive material.

36. Sample holder according to any one of claims 30 to 35, characterized in that
said sample holder is a standard DVD comprising a lower half disc (19), and an upper half disc (18) located on said lower half disc,
wherein
the surface of said upper half disc provides said sample holder surface, and
said upper half disc is made of a conductive material, in particular conductive polymer.

37. Sample holder according to any one of claims 30 to 36, characterized in that
said sample holder comprises at least two different measuring zones, each adapted to a different type of sample.

38. Sample holder according to any one of claims 30 to 37, characterized in that
said sample holder has a rectangular shape (24).

39. Method of manufacturing a sample holder comprising the steps of
providing a mass storage media (25) having a conductive mass storage media surface,
providing a measuring element (2) as a distinct component from said mass storage media, and
securing said measuring element (2) on said mass storage media surface.

40. Method of manufacturing a sample holder according to claim 39, characterized in that
said mass storage media (25) is a standard mass storage media, and
said step of providing a mass storage media (25) comprises a step of providing an electrically conductive coating (26) on the surface of said standard mass storage media, thereby providing said conductive mass storage media surface.

41. Method of manufacturing a sample holder according to claim 39 or 40, characterized in that
said mass storage media is a DVD, and
said step of providing a mass storage media (25) comprises:
providing a lower half disc (19) of said DVD,
providing an upper half disc (18) of said DVD made of conductive material, which upper half disc (18) has an upper half disc surface providing said conductive mass storage media surface,
joining said lower half disc (19) and said upper half disc (18), in order to obtain a complete DVD, wherein the surface of said DVD is said upper half disc surface.
